(19) United States
(12) Patent Application Publication
(10) Pub. No.: US 2026/0133056 A1
(43) Pub. Date: May 14, 2026

(54) ABSOLUTE ROTARY ENCODER FOR DETECTING THE ROTATIONAL MOVEMENT OF A SHAFT

(71) Applicant: FRABA B.V., SG HEERLEN (NL)

(72) Inventor: UWE KETTERING, HERMERSBERG (DE)

(73) Assignee: FRABA B.V., SG HEERLEN (NL)

(21) Appl. No.: 19/478,840

(22) PCT Filed: Mar. 18, 2025
(86) PCT No.: PCT/EP2025/057388

§ 371 Date: Oct. 27, 2025

(30) Foreign Application Priority Data
Mar. 19, 2024 (DE) 10 2024 107 829.4

(51) Int. Cl. G01D 5/16

(52) U.S. Cl. CPC G01D 5/16

(57) ABSTRACT

The invention refers to an absolute value rotary encoder (100) for detecting a rotational movement of a shaft (101), comprising: a revolution counting device (3) for determining a revolution count value (U), with a Wiegand sensor (3.1), a magnetic field sensor (3.2), and a permanent-magnetic rotor unit (3.3) which is designed to be mounted co-rotatably with the shaft (101) and which is designed in such a way that a magnetic field which alternates at least four times per revolution is generated by the permanent-magnetic rotor unit (3.3) in the mounted state in the case of a uniform rotational movement of the shaft (101) at the location of the Wiegand sensor (3.1), an angular position measuring device (4) for determining a current angular position (W) of the shaft (101), and an evaluation device (5) having a non-volatile data memory (5.1) in which the revolution count value (U) and a revolution sector value (US-g) are stored, wherein the evaluation device (5) is designed, after an interruption of the external energy supply: to determine a switch-on revolution sector value (US-e) on the basis of the current angular position (W) determined by the angular position measuring device (4), and to increase or decrease or leave unchanged a determined current absolute position (AP) depending on the determined switch-on revolution sector value (US-e) and the stored revolution sector value (US-g).

### CROSS REFERENCE TO PRIOR APPLICATIONS

This application is a U.S. National Phase application under 35 U.S.C. § 371 of International Application No. PCT/EP 2025/057388, filed on Mar. 18, 2025 and which claims benefit to German Patent Application No. 10 2024 107 829.4, filed on Mar. 19, 2024. The International Application was published in German on Sep. 11, 2025 as WO 2025/186481 A1 under PCT Article 21(2).

### FIELD

The present invention relates to an absolute value rotary encoder for detecting a rotational movement of a shaft, the absolute value rotary encoder comprising: a revolution counting device for determining a revolution count value, having a Wiegand sensor, a magnetic field sensor, and a permanent-magnetic rotor unit which is designed to be mounted on the shaft and which is designed so that an alternating magnetic field is generated by the permanent-magnetic rotor unit in the mounted state with a uniform rotational movement of the shaft at the location of the Wiegand sensor, an angular position measuring device for determining a current angular position of the shaft, and an evaluation device having a non-volatile data memory in which the revolution count value is stored, wherein the evaluation device is designed to determine a current absolute position on the basis of output signals of the Wiegand sensor and of the magnetic field sensor, the stored revolution count value and the current angular position determined by the angular position measuring device.

### BACKGROUND

Such an absolute value rotary encoder is described in WO 2004/046735 A1. The absolute value rotary encoder described therein detects a magnetization state of the Wiegand wire for synchronizing the revolution counting device and the angular position measuring device after an interruption of an external energy supply, which synchronizing determines a correct current absolute position by energizing a coil surrounding a Wiegand wire of the Wiegand sensor. Relatively complex electronics is, however, required for this purpose.

### SUMMARY

An aspect of the present invention is to provide an absolute value rotary encoder of the type mentioned above which operates reliably even after an interruption of an external energy supply and which can be produced relatively cost-effectively.

An absolute value rotary encoder for detecting a rotary movement of a shaft. The absolute value rotary encoder includes a revolution counting device for determining a revolution count value, an angular position measuring device for determining a current angular position of the shaft, and an evaluation device. The revolution counting device comprises a Wiegand sensor, a magnetic field sensor, and a permanent-magnetic rotor unit which is configured to be mounted co-rotatably with the shaft so that a magnetic field which alternates at least four times per revolution is generated by the permanent-magnetic rotor unit in a mounted state at the location of the Wiegand sensor during a uniform rotary movement of the shaft. The evaluation device comprises a non-volatile data memory in which the revolution count value and a revolution sector value are stored. The revolution sector value indicates one of a plurality of defined revolution sectors into which a complete revolution is subdivided in an evaluation-logic manner. The evaluation device is configured, in a case of an external energy supply, to determine a current revolution sector value based on an output signal of the Wiegand sensor, an output signal of the magnetic field sensor, and the stored revolution sector value, to either increase, decrease, or leave unchanged, the stored revolution count value based on the stored revolution sector value and the current revolution sector value, to determine a current absolute position based on the stored revolution count value and the current angular position determined by the angular position measuring device, and to store the current revolution sector value in the non-volatile data memory. The evaluation device is configured, after an interruption of the external energy supply, to determine a switch-on revolution sector value based on the current angular position determined by the angular position measuring device, wherein the switch-on revolution sector value indicates that one of the revolution sectors, in which a complete revolution is subdivided in an evaluation-logic manner, in which the current angular position determined by the angular position measuring device lies, and based on the determined switch-on revolution sector value and the stored revolution sector value, to either increase, decrease, or leave unchanged, the determined current absolute position.

### BRIEF DESCRIPTION OF THE DRAWINGS

The present invention is described in greater detail below on the basis of embodiments and of the drawings in which:

FIG. 1 schematically shows a sectional view of an absolute value rotary encoder according to the present invention for detecting a rotational movement of a shaft;

FIG. 2 schematically shows an evaluation device and a data interface of the absolute value rotary encoder of FIG. 1;

FIG. 3 schematically shows a rotor unit of the absolute value rotary encoder of FIG. 1, wherein different angular positions of the rotor unit are indicated by the respective position of a Wiegand sensor arranged on the stator unit;

FIG. 4 shows bit sequences of distinguishable states of revolution sector values processed by an evaluation device of the absolute value rotary encoder of FIG. 1;

FIG. 5 shows in tabular form a partial revolution counting logic stored in the evaluation device of the absolute value rotary encoder of FIG. 1 for determining a partial revolution count value of the bit sequences of the revolution sector values of FIG. 4;

FIG. 6 shows in tabular form a revolution counting logic stored in the evaluation device of the absolute value rotary encoder of FIG. 1 for determining the revolution count value when an external energy supply is present; and

FIG. 7 shows in tabular form a synchronization logic stored in the evaluation device of the absolute value rotary encoder of FIG. 1 for determining the revolution count value after an interruption of the external energy supply.

### DETAILED DESCRIPTION

The absolute value rotary encoder according to the present invention for detecting a rotational movement of a shaft comprises a revolution counting device for determining a current revolution count value. Such revolution counting devices are also referred to as multi-turn sensor devices and are generally known from the prior art. The revolution count value in this case generally indicates a number of complete revolutions covered since an initialization in a defined positive direction of rotation. The revolution count value is typically increased by one every time when a zero angle position is passed in the positive direction of rotation and is decreased by one every time when the zero angle position is passed in a negative direction of rotation opposite to the positive direction of rotation. It is also generally possible for the revolution count value to indicate a number of partial revolutions covered, for example, a number of half revolutions covered, in the positive direction of rotation. The number of complete revolutions covered can in any case, however, be derived directly and unambiguously from the revolution count value.

The absolute value rotary encoder according to the present invention for detecting a rotational movement of a shaft specifically comprises a Wiegand sensor-based revolution counting device which is generally known from the prior art and which comprises a Wiegand sensor, for example, a single Wiegand sensor, a magnetic field sensor, and a permanent-magnetic rotor unit, wherein the Wiegand sensor and the magnetic field sensor are designed to be arranged fixedly in relation to the shaft whose rotational movement is intended to be detected and the permanent-magnetic rotor unit is designed to be mounted co-rotatably with the shaft whose rotational movement is intended to be detected, i.e., to be mounted so that a rotational movement of the permanent-magnetic rotor unit necessarily follows a rotational movement of the shaft.

The Wiegand sensor comprises a Wiegand wire and a sensor coil surrounding the Wiegand wire. Such Wiegand sensors are also referred to as pulse wire sensors and are generally known from the prior art. Wiegand wires generally have a hard-magnetic sheath and a soft-magnetic core or vice versa. A magnetization direction of the Wiegand wire abruptly inverts under the action of an external magnetic field, as a result of which a short Wiegand voltage pulse is generated in the sensor coil radially surrounding the Wiegand wire, which pulse can be tapped via the sensor coil ends, i.e., the two ends of the sensor coil. This effect is referred to as the Wiegand effect or else as a macroscopic or large Barkhausen effect and is generally known.

The magnetic field sensor may generally be any desired magnetic field sensor known from the prior art, for example, a Hall sensor, a field plate, a TMR sensor, an AMR sensor, or a GMR sensor.

The permanent-magnetic rotor unit can, for example, be designed to be fastened directly to the shaft, with the result that the permanent-magnetic rotor unit and the shaft always rotate at the same speed. It is also generally possible, however, for the permanent-magnetic rotor unit to be coupled co-rotatably to the shaft via a gearing, with the result that the permanent-magnetic rotor unit and the shaft rotate at different speeds. The permanent-magnetic rotor unit is designed so that an alternating magnetic field is generated by the permanent-magnetic rotor unit in the mounted state with a uniform rotational movement of the shaft at the location of the Wiegand sensor. The permanent-magnetic rotor unit may, for example, comprise a permanent-magnetic ring magnet which is arranged circumferentially about an axis of rotation of the rotor unit and has a sequence of magnetic north poles and magnetic south poles along its circumference. The permanent-magnetic rotor unit may, however, also comprise a plurality of separate permanent magnets which are arranged on a circular path running around the axis of rotation of the rotor unit, wherein adjacent permanent magnets each have an opposite polarity. The permanent-magnetic rotor unit in any case comprises at least one permanent magnet.

According to the present invention, the permanent-magnetic rotor unit is specifically designed so that the magnetic field generated by the permanent-magnetic rotor unit in the mounted state at the location of the Wiegand sensor alternates at least four times per revolution with a uniform rotational movement of the shaft, with the result that a Wiegand voltage pulse is generated in the Wiegand sensor at at least four different angular positions, referred to below as triggering angular positions, in each case with a uniform rotational movement of the shaft per revolution. The permanent-magnetic rotor unit can, for example, be designed so that the magnetic field generated by the permanent-magnetic rotor unit in the mounted state at the location of the Wiegand sensor alternates with a constant frequency with a uniform rotational movement, with the result that the four triggering angular positions are approximately equidistant, i.e., there is always an approximately identical angular spacing between two respective successive triggering angular positions.

The absolute value rotary encoder according to the present invention for detecting a rotational movement of a shaft furthermore comprises an angular position measuring device for determining a current angular position of the shaft. Such angular position measuring devices are also referred to as single-turn sensor devices and are generally known from the prior art. The angular position in this case indicates a rotational position of the shaft, the rotational movement of which is intended to be detected, within one revolution and can consequently lie between 0° and 360°. The angular position measuring device comprises a rotor unit which, analogously to the permanent-magnetic rotor unit of the revolution counting device, is designed to be mounted co-rotatably with the shaft whose rotational movement is intended to be detected, and a stator unit which is designed to be arranged static in relation to the shaft whose rotational movement is intended to be detected. The stator unit typically comprises a sensor or detection electronics which interacts with a passive, i.e., not electrically contact-connected, coding element arranged on the rotor unit in order to determine the angular position, wherein the coding element is designed so that a physical property detected by the sensor or the detection electronics changes in a defined manner during a rotational movement of the rotor unit so that the current angular position can be derived from a current value of the physical property. The angular position measuring device may, for example, be an optical angular position measuring device in which the coding element comprises a defined sequence of light and dark regions which are scanned with an optical sensor. The angular position measuring device may, however, generally be any desired angular position measuring device known from the prior art, such as, for example, a magnetic angular position measuring device, a capacitive angular position measuring device, or an inductive angular position measuring device.

The absolute value rotary encoder according to the present invention for detecting a rotational movement of a shaft furthermore comprises an evaluation device with a non-volatile data memory, for example, with a so-called FRAM. In addition to the non-volatile data memory, the evaluation device comprises a processing electronics which is designed to process output signals or output values of the revolution counting device and of the angular position measuring device. The evaluation device typically comprises a microcontroller, a so-called FPGA, or another type of arithmetic unit.

According to the present invention, at least the revolution count value and a revolution sector value are stored in the non-volatile data memory, wherein the revolution sector value indicates one of a plurality of defined revolution sectors into which a complete revolution is subdivided in an evaluation-logic manner. The revolution sectors are in this case defined so that they each contain precisely one triggering angular position, i.e., each contain precisely one angular position at which a Wiegand voltage pulse is generated in the Wiegand sensor either with a rotational movement in the positive direction of rotation or with a rotational movement in the negative direction of rotation. Since the Wiegand voltage pulses are generated at different angular positions with a rotational movement in the positive direction of rotation and with a rotational movement in the negative direction of rotation, at least eight revolution sectors can be distinguished according to the present invention, i.e., a complete revolution is subdivided in an evaluation-logic manner into at least eight revolution sectors according to the present invention.

According to the present invention, the evaluation device is designed to determine a current revolution sector value when an external energy supply is present on the basis of current output signals of the Wiegand sensor and of the magnetic field sensor and the stored revolution sector value. In this case, based on the current output signals of the Wiegand sensor and on the magnetic field sensor, in a way known from the prior art, a pulse polarity value which indicates a polarity of the respectively generated Wiegand voltage pulse and a magnetic pulse value which indicates whether or not a magnetic field was detected by the magnetic field sensor at the time of the Wiegand voltage pulse are, for example, determined. The pulse polarity value and the magnetic pulse value in this case form (in binary-coded form) the last two bits of the revolution sector value. Since at least eight different revolution sector values must be distinguishable according to the present invention, the bit sequence of the revolution sector value must comprise at least one further bit. The at least one further bit in this case represents, for example, a count value which, on the basis of a defined count logic, is either increased by one or decreased by one or not changed based on the stored revolution sector value and the current pulse polarity value and the current magnetic pulse value.

According to the present invention, the evaluation device is furthermore designed to either increase or decrease or leave unchanged the stored revolution count value when an external energy supply is present based on a defined revolution count logic based on the stored revolution sector value and the current revolution sector value. The revolution count logic is in this case designed so that the revolution count value is increased by one when it can be derived from the stored revolution sector value and the current revolution sector value that the zero angle position was passed in the positive direction of rotation, that the revolution count value is decreased by one when it can be derived from the stored revolution sector value and the current revolution sector value that the zero angle position was passed in the negative direction of rotation, and that the revolution count value is not changed when it can be derived from the stored revolution sector value and the current revolution sector value that the zero angle position was not passed.

According to the present invention, the evaluation device is furthermore designed to determine a current absolute position in a known manner when an external energy supply is present on the basis of the stored revolution count value and the current angular position determined by the angular position measuring device, and to store the current revolution sector value in the non-volatile data memory after processing.

According to the present invention, the evaluation device is furthermore designed to carry out a synchronization between the revolution counting device and the angular position measuring device after an interruption of the external energy supply in that the revolution count value stored in the non-volatile data memory is, if necessary, adapted.

According to the present invention, the evaluation device is in particular designed to determine a switch-on revolution sector value after an interruption of the external energy supply based on the current angular position determined by the angular position measuring device, wherein the switch-on revolution sector value indicates that one of the revolution sectors, into which a complete revolution is subdivided in an evaluation-logic manner, in which the current angular position determined by the angular position measuring device lies.

According to the present invention, the evaluation device is furthermore designed to either increase or decrease or leave unchanged the determined current absolute position after an interruption of the external energy supply based on a defined synchronization logic based on the determined switch-on revolution sector value and the revolution sector value stored in the non-volatile data memory. The synchronization logic is in this case designed so that the revolution count value is increased by one during the determination of the current absolute position when it can be derived from the switch-on revolution sector value and the stored revolution sector value that the zero angle position was passed in the positive direction of rotation during the interruption of the external energy supply, that the revolution count value is decreased by one when determining the current absolute position when it can be derived from the switch-on revolution sector value and the stored revolution sector value that the zero angle position was passed in the negative direction of rotation during the interruption of the external energy supply, and that the revolution count value is not changed during determination of the current absolute position when it can be derived from the switch-on revolution sector value and the stored revolution sector value that the zero angle position was not passed during the interruption of the external energy supply. The synchronization logic can alternatively also be designed so that, instead of increasing or decreasing or not changing the revolution count value during determination of the current absolute position, a previously determined current absolute position is increased by one full revolution or decreased by one full revolution or not changed by one full revolution.

The absolute value rotary encoder according to the present invention thus makes it possible to determine a correct current absolute position after an interruption of the external energy supply without the magnetization state of the Wiegand wire having to additionally be detected for this purpose by energizing a coil surrounding the Wiegand wire of the Wiegand sensor. This makes it possible to implement an absolute value rotary encoder for detecting a rotational movement of a shaft which operates reliably even after an interruption of an external energy supply which can also be produced relatively cost-effectively.

In an embodiment of the present invention, the permanent-magnetic rotor unit can, for example, comprise a rotor circuit board and at least four permanent magnets fastened to the rotor circuit board, as a result of which the permanent-magnetic rotor unit can be produced relatively cost-effectively. The coding element of the angular position measuring device can also be arranged on the rotor circuit board, with the result that no additional support element must be provided for the coding element of the angular position measuring device.

The permanent-magnetic rotor unit can, for example, be designed so that the magnetic field generated by the permanent-magnetic rotor unit in the mounted state with a uniform rotational movement of the shaft at the location of the Wiegand sensor alternates precisely four times per revolution. This makes it possible to implement a permanent-magnetic rotor unit which can be produced very cost-effectively.

The permanent-magnetic rotor unit can, for example, be designed to be mounted on an outer circumferential surface of the shaft, with the result that the permanent-magnetic rotor unit can be mounted both on a solid shaft and on a hollow shaft. An absolute value rotary encoder which can be used in a particularly versatile manner can thereby be implemented.

In an embodiment of the present invention, the magnetic field sensor can, for example, be a so-called TMR sensor which is relatively cost-effective and for the operation of which only a relatively small amount of electrical energy is required.

The absolute value rotary encoder can, for example, be designed so that, in the mounted state, the Wiegand sensor and/or the magnetic field sensor is/are arranged axially adjacent to the permanent-magnetic rotor unit. An absolute value rotary encoder can thereby be implemented for which only a relatively small amount of radial installation space is required.

The angular position measuring device can, for example, be a capacitive angular position measuring device which only requires a relatively small amount of electrical energy to operate. Capacitive angular position measuring devices comprise at least two asymmetrically shaped electrodes which are designed so that an electrical capacitance between the two electrodes changes as a result of a rotation of the electrodes with respect to one another.

An embodiment of the present invention is described below with reference to the enclosed drawings.

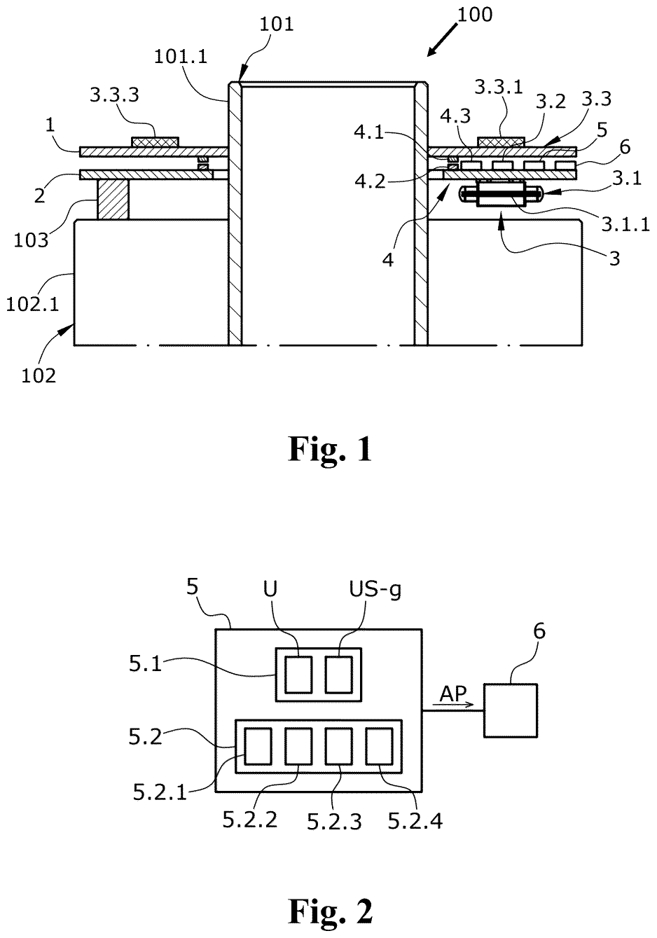

FIG. 1 schematically shows an absolute value rotary encoder 100 according to the present invention for detecting a rotational movement of a shaft 101 in the mounted state, wherein the shaft 101 is designed as a hollow shaft and is driven by a drive motor 102.

The absolute value rotary encoder 100 comprises an annular-disk-shaped rotor circuit board 1 which radially surrounds the shaft 101 and which is fastened directly to an outer circumferential surface 101.1 of the shaft 101 and consequently co-rotates with the shaft 101.

The absolute value rotary encoder 100 furthermore comprises a stator circuit board 2 which is fastened to a housing 102.1 of the drive motor 102 via a plurality of fastening device 103 and is consequently arranged static in relation to the shaft 101.

The absolute value rotary encoder 100 furthermore comprises a magnet-based revolution counting device 3 for determining a current revolution count value U, wherein the revolution counting device 3 has a Wiegand sensor 3.1, a magnetic field sensor 3.2 designed as a TMR sensor, and a permanent-magnetic rotor unit 3.3 which is defined by the rotor circuit board 1 and four permanent magnets 3.3.1-3.3.4 which are attached to the rotor circuit board 1.

The Wiegand sensor 3.1 and the magnetic field sensor 3.2 are arranged axially adjacent to the permanent-magnetic rotor unit 3.3 on the stator circuit board 2, wherein the Wiegand sensor 3.1 and the magnetic field sensor 3.2 are arranged adjacent to one another in the circumferential direction of the shaft 101.

The Wiegand sensor 3.1 is in this case arranged so that a Wiegand wire 3.1.1 of the Wiegand sensor 3.1 extends in a radial direction of the shaft 101.

The permanent magnets 3.3.1-3.3.4 are designed as diametrically magnetized disk magnets and are arranged on the rotor circuit board 1 so that their magnetization direction in each case extends substantially parallel to a radial direction of the shaft 101, i.e., so that the magnetic poles N, S are in each case arranged adjacent in the radial direction, wherein permanent magnets 3.3.1-3.3.4 adjacent in the circumferential direction of the shaft 101 have opposite magnetization directions.

A magnetic field is therefore generated by the permanent-magnetic rotor unit 3.3 with a uniform rotational movement of the shaft 101 at the location of the Wiegand sensor 3.1, which magnetic field alternates precisely four times per revolution of the shaft 101, i.e., its polarity changes precisely four times.

The absolute value rotary encoder 100 furthermore comprises a capacitive angular position measuring device 4 for determining a current angular position W, wherein the angular position measuring device 4 is provided with a rotor electrode arrangement 4.1 which is arranged on the rotor circuit board 1 so as to surround the shaft 101, a stator electrode arrangement 4.2 arranged on the stator circuit board 2 so as to surround the shaft 101, and measuring electronics 4.3 arranged on the stator circuit board 2.

The absolute value rotary encoder 100 furthermore comprises an evaluation device 5 which has a non-volatile data memory 5.1 in the form of a FRAM, in which the current revolution count value U and a revolution sector value US-g are stored, and a computing unit 5.2 in which a partial revolution counting logic 5.2.1, a revolution counting logic 5.2.2, a synchronization logic 5.2.3, and an absolute position determination logic 5.2.4 are stored.

The absolute value rotary encoder 100 furthermore comprises a data interface 6 via which data of the absolute value rotary encoder 100, in particular a determined current absolute position AP, can be read externally.

The stored revolution sector value US-g and also a current revolution sector value US-a determined as described below and a switch-on revolution sector value US-e determined as described below are each 3-bit values, wherein the last bit indicates a pulse polarity value PP, the middle bit indicates a magnetic pulse value MP, and the first bit indicates a partial revolution count value TW.

The revolution sector values US-g, US-a, US-e, referred to below only as US in the generally valid case, can each indicate the eight different states P1-P4, N1-N4 illustrated in FIG. 4 with the bit sequences also illustrated in FIG. 4, wherein each state is assigned an unambiguous angular position range with a width of 360°/8=45° in each case.

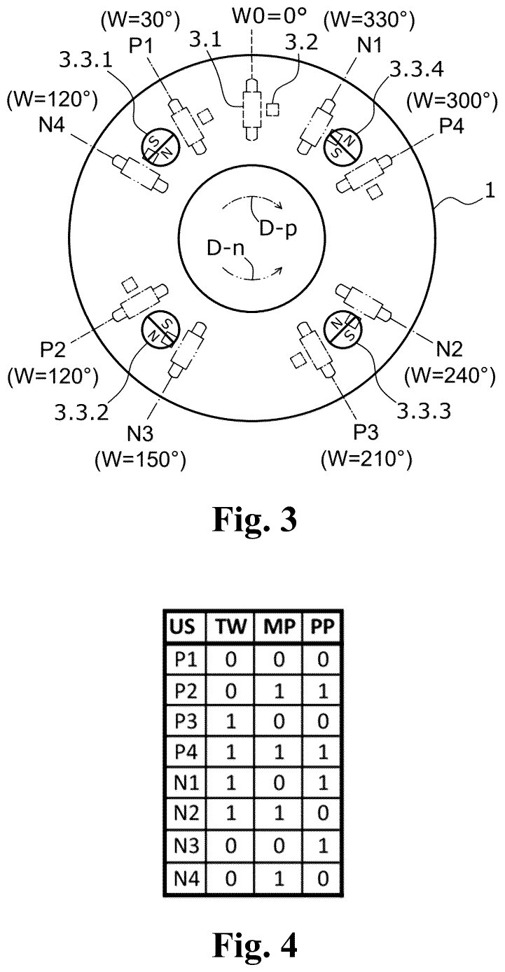

Each of the states P1-P4, N1-N4 is in this case assigned, as illustrated schematically in FIG. 3, a triggering angular position, i.e., an angular position of the permanent-magnetic rotor unit 3.3 at which a Wiegand voltage pulse is generated in the Wiegand sensor 3.1, wherein the states P1-P4 correspond to triggering angular positions with a rotation in a positive direction of rotation D-p and the states N1-N4 correspond to triggering angular positions with a rotation in a negative direction of rotation D-n opposite to the positive direction of rotation D-p.

For the sake of simplicity, FIG. 3 illustrates the different triggering angular positions of the permanent-magnetic rotor unit 3.3 by a rotation of the Wiegand sensor 3.1 and of the magnetic field sensor 3.2 opposite to the respective direction of rotation D-p, D-n proceeding from a zero angle position WO, a rotation of the permanent-magnetic rotor unit 3.3 in the positive direction of rotation D-p is thus illustrated by a rotation of the Wiegand sensor 3.1 and of the magnetic field sensor 3.2 in the negative direction of rotation D-n and vice versa.

The evaluation device 5 is designed to determine a current pulse polarity value PP which indicates a polarity of the last Wiegand voltage pulse generated in the Wiegand sensor 3.1 and a current magnetic pulse value MP which indicates whether or not a magnetic field was detected by the magnetic field sensor 3.2 at the time of the Wiegand voltage pulse in a known manner on the basis of output signals of the Wiegand sensor 3.1 and of the magnetic field sensor 3.2 when an external energy supply is present.

The evaluation device 5 is furthermore designed to determine a current revolution sector value US-a when an external energy supply is present based on the stored revolution sector value US-g, the current magnetic pulse value MP, and the current pulse polarity value PP.

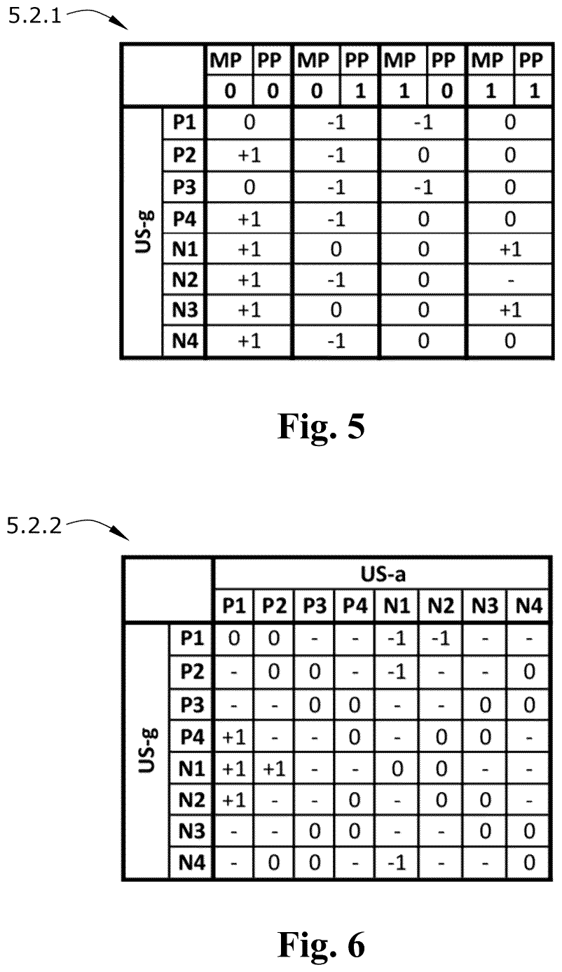

It is in this case decided based on the partial revolution counting logic 5.2.1 illustrated in tabular form in FIG. 5 based on the stored revolution sector value US-g, the current magnetic pulse value MP, and the current pulse polarity value PP, whether the partial revolution count value TW of the stored revolution sector value US-g must be increased by one (+1) or decreased by one (−1) or not changed (0), as a result of which the current partial revolution count value TW and consequently the current revolution sector value US-a resulting from the current partial revolution count value TW, the current magnetic pulse value MP, and the current pulse polarity value PP is determined.

The evaluation device 5 is furthermore designed to either increase the revolution count value U stored in the non-volatile data memory 5.1 by one (+1) or decrease it by one (−1) or leave it unchanged (0) when an external energy supply is present on the basis of the revolution counting logic 5.2.2 illustrated in tabular form in FIG. 6 on the basis of the stored revolution sector value US-g and the previously determined current revolution sector value US-a.

The evaluation device 5 is furthermore designed to determine a current absolute position AP which can then be read via the data interface 6 when an external energy supply is present via the absolute position determination logic 5.2.4 in a known manner based on the stored revolution count value U and the current angular position W determined by the angular position measuring device 4.

The evaluation device 5 is furthermore designed to store the current revolution sector value US-a in the non-volatile data memory 5.1 after processing when an external energy supply is present, i.e., to replace the stored revolution sector value US-g by the current revolution sector value US-a.

The evaluation device 5 is furthermore designed to carry out a synchronization between the revolution counting device 3 and the angular position measuring device 4 after an interruption of the external voltage supply.

The evaluation device 5 is in particular designed to determine a switch-on revolution sector value US-e after an interruption of the external voltage supply based on the current angular position W determined by the angular position measuring device 4 by checking in which of the angular position ranges assigned to the eight states P1-P4, N1-N4 the current angular position W lies.

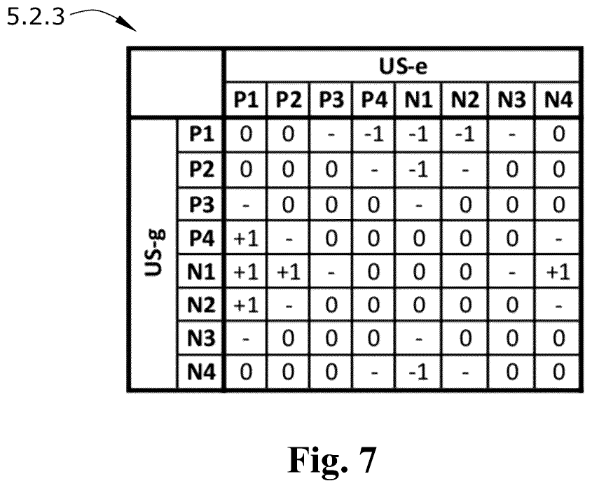

The evaluation device 5 is in particular furthermore designed to either increase the current absolute position AP previously determined via the absolute position determination logic 5.2.4 by one full revolution (+1) or to decrease it by one full revolution (−1) or to leave it unchanged (0) or to increase the stored revolution count value U by one (+1) or to decrease it by one (−1) or to leave it unchanged (0) when determining the current absolute position AP on the basis of the synchronization logic 5.2.3 illustrated in tabular form in FIG. 7 on the basis of the previously determined switch-on revolution sector value US-e and the revolution sector value US-g stored in the non-volatile data memory 5.1.

The present invention is not limited to embodiments described herein; reference should be had to the appended claims.

### LIST OF REFERENCE CHARACTERS

100 Absolute value rotary encoder
1 Rotor circuit board
2 Stator circuit board
3 Revolution counting device
3.1 Wiegand sensor
3.1.1 Wiegand wire
3.2 Magnetic field sensor
3.3 Permanent-magnetic rotor unit
3.3.1 Permanent magnet
3.3.2 Permanent magnet
3.3.3 Permanent magnet
3.3.4 Permanent magnet
4 Angular position measuring device
4.1 Rotor electrode arrangement
4.2 Stator electrode arrangement
4.3 Measuring electronics
5 Evaluation device
5.1 Non-volatile data memory
5.2 Computing unit
5.2.1 Partial revolution counting logic
5.2.2 Revolution counting logic
5.2.3 Synchronization logic
5.2.4 Absolute position determination logic
6 Data interface
101 Shaft
101.1 Outer circumferential surface
102 Drive motor
102.1 Housing
103 Fastening device
AP Current absolute position
D-n Negative direction of rotation
D-p Positive direction of rotation
MP Current magnetic pulse value
N1-N4 Revolution sector values for negative direction of rotation
P1-P4 Revolution sector values for positive direction of rotation
PP Current pulse polarity value
TW Partial revolution count value
U Revolution count value
US-a Current revolution sector value
US-g Stored revolution sector value
US-e Switch-on revolution sector value
W Current angular position
WO Zero angle position

What is claimed is:

1. Absolute value rotary encoder (100) for detecting a rotary movement of a shaft (101), comprising:
a revolution counting device (3) for determining a revolution count value (U), with
a Wiegand sensor (3.1),
a magnetic field sensor (3.2), and
a permanent-magnetic rotor unit (3.3) which is designed to be mounted co-rotatably with the shaft (101) and which is designed in such a way that a magnetic field which alternates at least four times per revolution is generated by the permanent-magnetic rotor unit (3.3) in the mounted state in the case of a uniform rotary movement of the shaft (101) at the location of the Wiegand sensor (3.1),
an angular position measuring device (4) for determining a current angular position (W) of the shaft (101), and
an evaluation device (5) with a non-volatile data memory (5.1) in which the revolution count value (U) and a revolution sector value (US-g) are stored,
wherein the evaluation device (5) is designed, in the case of an existing external energy supply:
to determine a current revolution sector value (US-a) on the basis of output signals of the Wiegand sensor (3.1) and of the magnetic field sensor (3.2) and the stored revolution sector value (US-g),
on the basis of the stored revolution sector value (US-g) and the current revolution sector value (US-a), to either increase or decrease the stored revolution count value (U) or to leave it unchanged,
to determine a current absolute position (AP) on the basis of the stored revolution count value (US-g) and the current angular position (W) determined by the angular position measuring device (4), and
to store the current revolution sector value (US-a) in the non-volatile data memory (5.1) after the processing,
and wherein the evaluation device (5) is designed, after an interruption of the external energy supply:
to determine a switch-on revolution sector value (US-e) on the basis of the current angular position (W) determined by the angular position measuring device (4), and
on the basis of the determined switch-on revolution sector value (US-e) and the stored revolution sector value (US-g), to either increase or decrease the determined current absolute position (AP) or to leave it unchanged.

2. Absolute value rotary encoder (100) according to claim 1, wherein the permanent-magnetic rotor unit (3.3) comprises a rotor circuit board (1) and at least four permanent magnets (3.3.1-3.3.4) which are fastened to the rotor circuit board (1).

3. Absolute value rotary encoder (100) according to one of the preceding claims, wherein the permanent-magnetic rotor unit (3.3) is designed in such a way that the magnetic field which is generated by the permanent-magnetic rotor unit (3.3) in the mounted state in the case of a uniform rotary movement of the shaft (101) at the location of the Wiegand sensor (3.1) alternates exactly four times per revolution.

4. Absolute value rotary encoder (100) according to one of the preceding claims, wherein the permanent-magnetic rotor unit (3.3) is designed to be mounted on an outer circumferential surface (101.1) of the shaft (101).

5. Absolute value rotary encoder (100) according to one of the preceding claims, wherein the magnetic field sensor (3.2) is a TMR sensor.

6. Absolute value rotary encoder (100) according to one of the preceding claims, wherein the Wiegand sensor (3.1) and/or the magnetic field sensor (3.2) is/are arranged axially adjacent to the permanent-magnetic rotor unit (3.3).

7. Absolute value rotary encoder (100) according to one of the preceding claims, wherein the angular position measuring device (4) is a capacitive angular position measuring device.
